(19) United States
(12) Patent Application Publication
(10) Pub. No.: US 2008/0085414 A1
(43) Pub. Date: Apr. 10, 2008

(54) Optical Substrate and Method of Manufacture

(76) Inventor: Hakchu Lee, San Jose, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/530,634

(22) Filed: Sep. 11, 2006

(51) Int. Cl. B32B 9/00; B32B 19/00

(52) U.S. Cl. 428/411.1; 428/702; 428/696

(57) ABSTRACT

An apparatus is an optical substrate having a defined refractive index. A primary optical coating is disposed on a first major surface of the substrate and a secondary coating having a refractive index substantially similar to the defined refractive index is disposed on a second major surface of the substrate. A method for manufacturing an optical substrate comprises depositing a primary coating on the first major surface of the optical substrate and depositing a secondary coating having a refractive index substantially similar to the defined refractive index on the second major surface of the optical substrate.

### BACKGROUND

Energetic deposition processes to coat optical substrates have certain spectral function advantages. Unfortunately, the energetic deposition processes often result in a coating exhibiting high intrinsic compressive stress. If left unaddressed, the stress from the coating warps the optical film and causes unacceptable optical distortion for many optical applications.

One solution to the mechanical stress deposits a symmetrical stress balancing stack of coatings on the surface of the optical film opposite the surface with the original coatings. The justification is that a symmetrical stack exhibits equal compressive stress on opposing surface thereby flattening out the substrate to remove the optical distortion induced by the original compressive stress. Disadvantageously, the symmetrical stack changes the spectral properties of the optical substrate. If the substrate is used primarily for reflective applications such that the light does not reach the symmetrical stress balancing stack, then the stress balancing stack that addresses the distortion issues related to mechanical stress does not adversely affect the intended function of the optical substrate. This solution, however, is inappropriate for transmissive functions of the substrate.

Another solution creates a stress balancing stack comprising optically absent layers sufficient to counteract the compressive stress of the primary stack. Each layer in the stress balancing stack is optically absent by being an integral multiple of half wavelengths of the design frequency of light that is to be used. Disadvantageously, each layer is optically absent only at a single wavelength. Additionally, a post coating process to optimize the beam parallelism of the coated substrate removes a portion of the stress balancing stack material. This process creates location dependent phase change of the light for the outside layer which results in wavefront propagation error and a change in the polarization state of the light.

Due to the disadvantages of current solutions, there remains a need for a coated optical substrate that has good performance in multiple wavelength applications.

### BRIEF DESCRIPTION OF THE DRAWINGS

An understanding of the present teachings can be gained from the following detailed description, taken in conjunction with the accompanying drawings of which like reference numerals in different drawings refer to the same or similar elements.

FIG. 1 is an illustration of an optical substrate coated with layers that exhibit compressive stress.

FIG. 2 is an illustration of an optical substrate according to the present teachings having a stress balancing or secondary coating.

FIG. 3 is a diagram showing an embodiment of a process for deposition of first and second materials to comprise the secondary coating.

FIG. 4 is a diagram showing additional detail of a secondary coating according to the present teachings.

FIG. 5 is a flow chart of an embodiment of a method according to the present teachings for depositing the secondary coating.

FIG. 6 is a flow chart of an embodiment of a method according to the present teachings for developing a recipe for an appropriate secondary coating.

FIG. 7 is a flow chart of an embodiment of a method according to the present teachings for developing a recipe for a secondary coating appropriate for use with a specific substrate aspect ratio and primary coating.

FIG. 8 is a diagram showing another possible embodiment of a process for deposition of first and second material to comprise the secondary coating.

### DETAILED DESCRIPTION

In the following detailed description, for purposes of explanation and not limitation, example embodiments disclosing specific details are set forth in order to provide an understanding of embodiments according to the present teachings. However, it will be apparent to one of ordinary skill in the art with benefit of the present disclosure that other embodiments according to the present teachings that depart from the specific details disclosed herein remain within the scope of the appended claims. Moreover, descriptions of well-known apparatus and methods may be omitted so as to not obscure the description of the example embodiments. Such methods and apparatus are clearly within the scope of the present teachings.

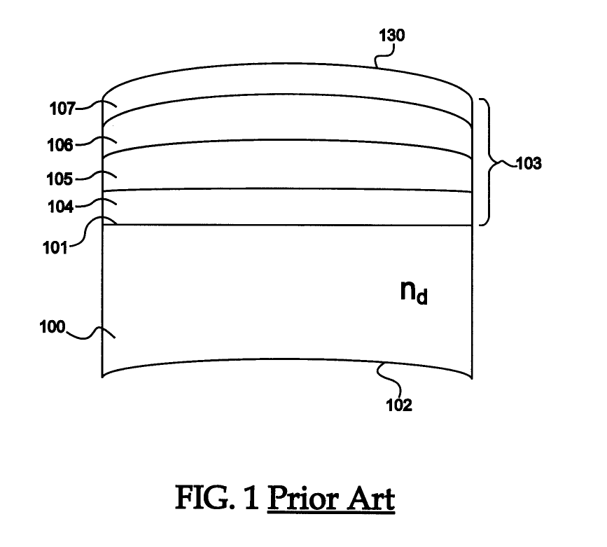

With specific reference to FIG. 1 of the drawings, there is shown an optical substrate 100 having a first major surface 101 and a second major surface 102. The optical substrate 100 is flat prior to deposition of one or more layers of a primary coating 103. Each coating layer 104, 105, 106, 107 provides a spectral function so the primary coating 103 provides a specifically desired overall spectral response function for a specific application. An example of a specific application of an optical substrate is a beam splitting function. The beam splitter coatings are part of a class of interference coatings. In the class of interference coatings, the propagation of light is controlled through interference at each layer of the coating. Because light can be represented as a wave, light interferes as a result of reflections from coating layer boundaries and from thicknesses of coating layers. Additionally, radiant absorption due to the interference coatings is less than that of metal coatings (e.g., Al, Au, Ag etc.). If reflection is known, transmission is approximately 1-reflection, where reflection is represented as a decimal value of less than 1. Depending upon the specifically desired optical properties, each layer has reflective and transmissive properties designed for the specific application.

Advantageously, coatings applied using an energetic deposition process produce repeatable refractive indices and accurate layer thicknesses. Energetic deposition processes also produce environmentally stable coatings. Due to high physical density, adsorption of water into the coating is minimized. Hence with humidity, spectral response is invariant.

Disadvantageously, coatings applied using an energetic deposition process exhibit compressive stress to the optical substrate 100 causing it to warp in a convex direction as shown in FIG. 1 of the drawings. Left unaddressed, the convex warping optically distorts the substrate 100 rendering it less effective or unusable for the desired application.

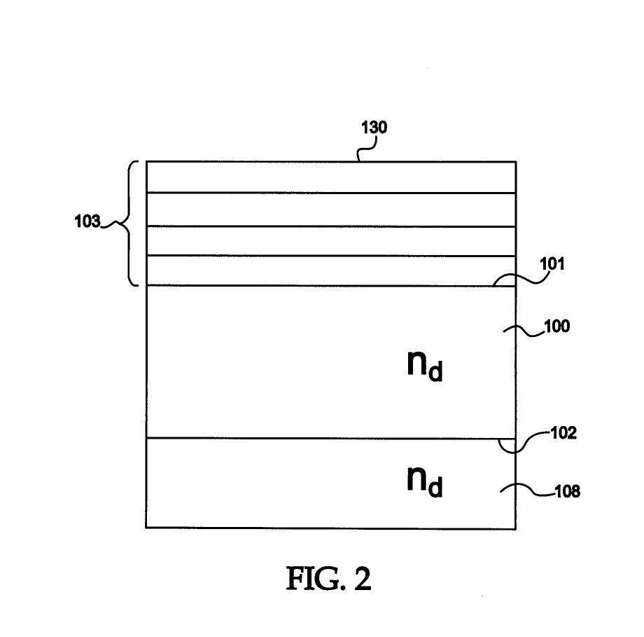

With specific reference to FIG. 2 of the drawings, it is suggested that a stress balancing secondary coating 108 may be applied to the second major surface 102 of the optical substrate 100. If the secondary coating 108 applies an equal and opposite stress to the optical substrate 100 coated with the primary coating 103, the compressive stress of the primary coating 103 may be neutralized by the opposite compressive stress of the secondary coating 108 to minimize or eliminate optical distortion due to warping. In order to maintain the optical properties of the optical substrate 100 for use in a transmissive application, it is recommended that a refractive index of the secondary coating 108 be substantially equal to a refractive index of the optical substrate 100. The refractive index of the optical substrate 100 therefore, establishes a defined refractive index (n_{d}). One of ordinary skill in the art appreciates that matching the defined refractive index simulates the important function of the optical substrate material for transmissive applications.

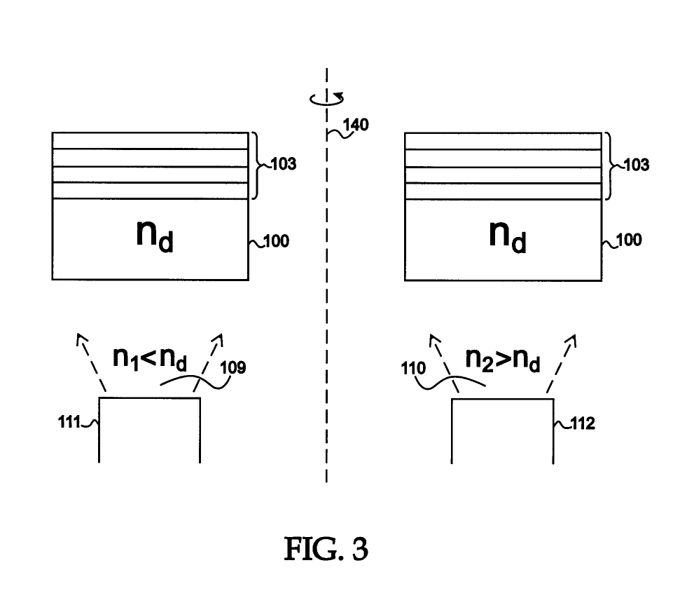

The defined refractive index (n_{d}) is achieved by combining first and second materials as part of the secondary coating deposition process. With specific reference to FIG. 3 of the drawings, there is shown a simplified illustration of how combination of the first material 109 and the second material 110 is achieved during the energetic deposition process of the secondary coating 108. The first and second materials 109, 110 are selected as boundaries around the defined index of refraction. The first material 109 has a first index of refraction (n₁) below the defined refractive index (n₁<n_{d}) and the second material 110 has a second index of refraction (n₂) above the defined refractive index (n₂>n_{d}). A first deposition element 111 deposits a first monolayer thickness, t₁, of the first material 109 and a second deposition element 112 deposits a second monolayer thickness, t₂, of the second material 110.

The HELIOS™ tool manufactured and sold by Leybold Optics of Alzenau, Germany is appropriate for the energetic deposition of the first and second materials 109, 110 to create the secondary coating 108 according to the present teachings. Other tools and methods for energetic deposition of a secondary coating may also be appropriate for use in conjunction with the present teachings.

In the HELIOS tool, a coating layer of index n_{d} is formed by depositing multiple very thin alternating monolayers of the first and second materials 109, 110. For purposes of the present disclosure, a “monolayer” refers to a single layer of the first or second material having an optical thickness that is significantly less than a wavelength of light designed for the relevant optical substrate 100. Specifically, each monolayer thickness is no more than 10% of the design wavelength of light and more typically less than 1% of the design wavelength of light. Therefore, each monolayer thickness is likely to be in the range of less than 50 Angstroms. The secondary coating 108 comprising aggregated alternating monolayers of the first and second materials 109, 110 can be represented by an effective index of refraction which is a weighted average of the respective indices of refraction, n₁ and n₂. A composite monolayer 131 comprises one monolayer of the first material 109 and one monolayer of the second material 110. The composite monolayer 131 produces the effective index of refraction of n_{d}. Multiple composite monolayers 130 comprise the secondary coating 108 that balances the compressive stress of the primary coating 103. Because the thickness of the monolayers is significantly less than the wavelength of light, the light responds to the resulting aggregated monolayers as a solid material having an effective index of refraction as established by the relative thicknesses of the monolayers and the respective indices of refraction. With specific reference to FIG. 3 of the drawings, a simplified embodiment of a deposition tool appropriate for use according to the present teachings is shown. A specific embodiment of the co-deposition process uses the HELIOS deposition tool that provides for placement of the substrate 100 in a fixture that continuously rotates in a single plane and about a tool axis 140. When the substrate 100 is in a first position, the substrate 100 accepts the first material 109 from a first source 111 at a specific deposition rate. The thickness of the monolayer of the first material 109 that is deposited is based upon the deposition parameters for the first source. As the tool continues to rotate through the first position and about its axis, the substrate 100 is repositioned to a second position where it accepts deposition of the second material 110 at another specific deposition rate. If more of the first material 109 is to be deposited relative to the second material 110, the tool is configured so that the deposition rate of the first material 109 is higher than the deposition rate of the second material 110. The rotating fixture of the tool alternatingly positions the substrate 100 to be aligned with the first source 111 and then the second source 112 to deposit alternating monolayers of the first and second materials 109, 110. The rotation/deposition process continues until a desired thickness comprising a plurality of the composite monolayers is deposited onto the substrate 100.

In a specific embodiment, determining a recipe for the secondary coating 108 first calculates an appropriate ratio of the thicknesses of the monolayers of the first and second materials 109, 110 to produce the desired index of refraction, n_{d}. The appropriate ratio is calculated using a weighted average of the respective indices of refraction and respective thicknesses, t₁ and t₂, of the monolayers for the first and second materials 109, 110.

For purposes of illustration, the following example is provided. An optical substrate 100 made of BK-7 has an index of refraction equal to 1.515 at the design wavelength of 633 nm. It is desired to match the index of refraction of 1.515 with a combination of the first and second materials 109, 110 to create the secondary coating 108. The compressive stress of the secondary coating 108 that overcomes the compressive stress of the primary coating 103 is defined by the total thickness of the stress balancing layer or secondary coating 108. In a specific embodiment, the first material is silicon dioxide (SiO₂) also commonly referred to as silica having an index of refraction of n₁=1.46 and the second material is niobium pentoxide (Nb₂O₅) also commonly referred to as niobia having an index of refraction of n₂=2.35. If silica is chosen as the first material and niobia is chosen as the second material, the thickness of the first material (n₁) layers will be greater than the thickness of the second material (n₂) layers to arrive at the weighted average of 1.515. Specifically:

$$\frac{{t}_{1}}{{t}_{cml}} {n}_{l} + \frac{{t}_{2}}{{t}_{cml}} {n}_{h} = {n}_{d} where {t}_{1} + {t}_{2} = {t}_{cml} \qquad \text{(1)}$$

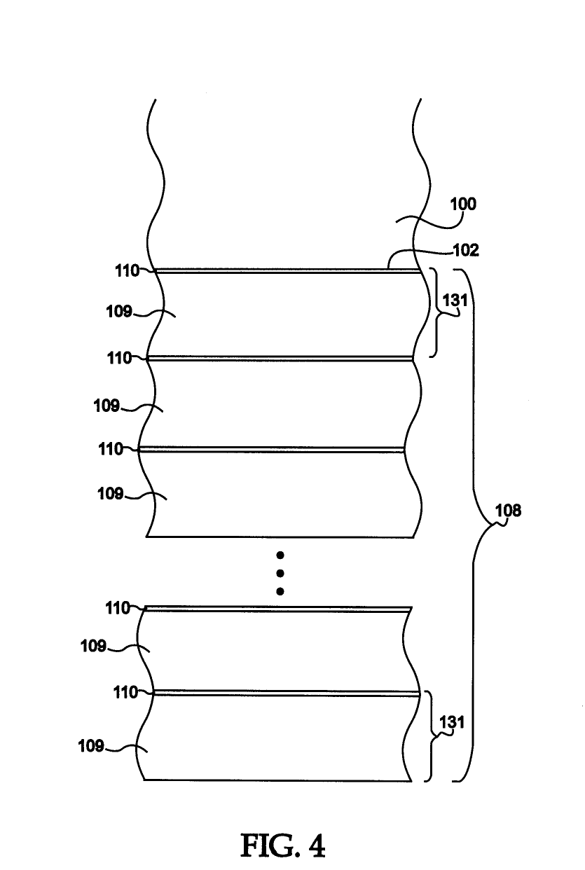

The variable t₁ is a thickness of a monolayer of the first material 109, t₂ is a thickness of a monolayer of the second material 110, and t_{cml} is a thickness of the composite monolayer 130 that combines the monolayers of the first and second materials 109, 110. With specific reference to FIG. 4 of the drawings, there is shown a representative illustration of the monolayers that comprise the secondary coating 108. The large number of monolayers that are required to achieve the secondary coating 108 that balances the compressive stress of the primary coating 103 are too numerous to illustrate directly. The monolayers of each material 109, 110 are alternatingly deposited on the second major surface 102 of the optical substrate 100 until the desired thickness is achieved to balance the compressive stress of the primary coating 103. The equation for the defined index of refraction (n_{d}) of the total thickness (tₜₒₜₐₗ) of the secondary coating 108 based upon the aggregated monolayers and the respective indices of refraction of each monolayer is:

$${\sum }_{1}^{m} ( {n}_{1} {t}_{1} + {n}_{2} {t}_{2} ) = {n}_{d} {t}_{total} \qquad ( 2 )$$

Where tₜₒₜₐₗ is a total thickness of the secondary coating 108, n_{d} is the defined index of refraction, and m is the number of composite monolayers 130 in the secondary coating 108. The total thickness of the secondary coating 108 that is consistent with the specific embodiment described is typically on the order of 1-3 microns.

To calculate the appropriate ratio of first material monolayer thickness to second material monolayer thickness in the specific example, the variables that represent the indices of refraction for the specific values of the example are substituted in the equation (1). In addition, this example assumes the total thickness of the composite monolayers is 20 Angstroms. Therefore:

$$\frac{{t}_{1}}{20} ( 1.46 ) + \frac{{t}_{2}}{20} ( 2.35 ) = 1.515 and {t}_{1} + {t}_{2} = 20 \qquad ( 3 )$$

With two equations and two unknowns, it is possible to solve for the two unknowns. Solving results in t₁=18.76 A or approximately 19 Angstroms and t₂=1.24 A or approximately 1 Angstrom. Therefore, the calculation directs that a monolayer of approximately 19 Angstroms of the first material having an index of refraction of 1.46 be deposited for each monolayer of approximately 1 Angstrom of the second material. Multiple 20 Angstrom composite layers are then deposited to achieve the desired thickness of the secondary coating 108 that balances the compressive stress of the primary coating 103. As one of ordinary skill in the art appreciates, a differently sized composite layer of thickness tₜₒₜₐₗ renders monolayers of different thicknesses, but the desired index of refraction and the relationship to the indices of refraction for the first and second materials 109, 110 establishes the ratio of the relative thicknesses of the monolayers for the first and second materials 109, 110.

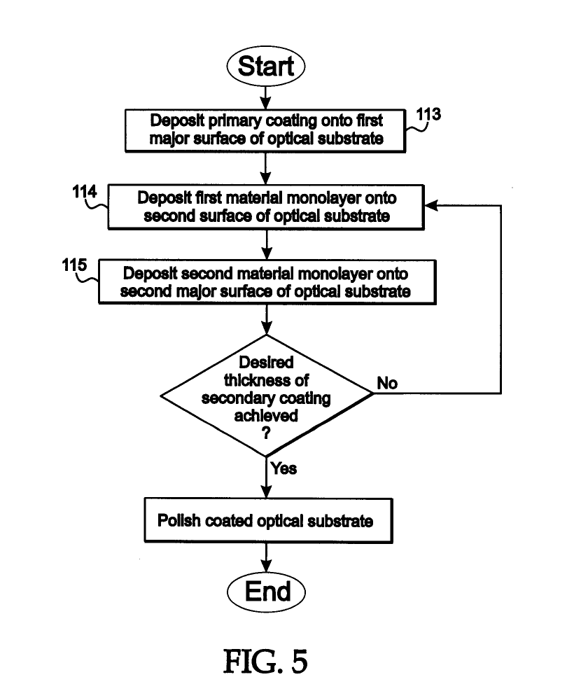

With specific reference to FIG. 5 of the drawings, there is shown a flow chart according to the present teachings for manufacturing a coated optical substrate 100. Specifically, the primary coating 103 that may comprise two or more layers of optical coating material are deposited 113 onto the first major surface 101 of the optical substrate 100. One of the monolayers of the first material 109 is then deposited 114 onto the second major surface of the coated optical substrate 100 followed immediately by deposition 115 of one of the monolayers of the second material 110. If the aggregated monolayers do not yet equal a desired thickness of the secondary coating 108, additional first material 109 and second material 110 monolayers are deposited 114, 115 until the desired thickness of the secondary coating 108 is reached. The optical substrate 100 with the primary and secondary coatings 103, 108 may then be polished to achieve improved beam parallelism or not polished. Because the effective index of refraction of the secondary coating 108 matches the index of refraction of the optical substrate 100, there is no optical boundary or interface between the optical substrate 100 and the secondary coating 108 that affects the behavior of light passing through it. Therefore, the secondary coating 108 does not function as an interference coating and polishing the secondary coating 108 does not affect the spectral response.

The recipe for the secondary coating 108 that appropriately opposes each primary coating 103 is established empirically for each primary coating 103 according to substrate thickness and aspect ratio. As one of ordinary skill in the art appreciates, each different primary coating 103 has one and may have more secondary coatings 108 that can balance the compressive stress of the primary coating 103. Stress compensating coatings with matched indices of refraction are developed for many types of substrates. For example and without limitation, Bk-7 substrate material has an index of refraction of 1.515 at 633 nm and SF10 substrate has an index of refraction of 1.71. Accordingly, each substrate material has a associated with it a first and second material, monolayer thicknesses, and total thickness to balance the compressive stress of the primary coating 103.

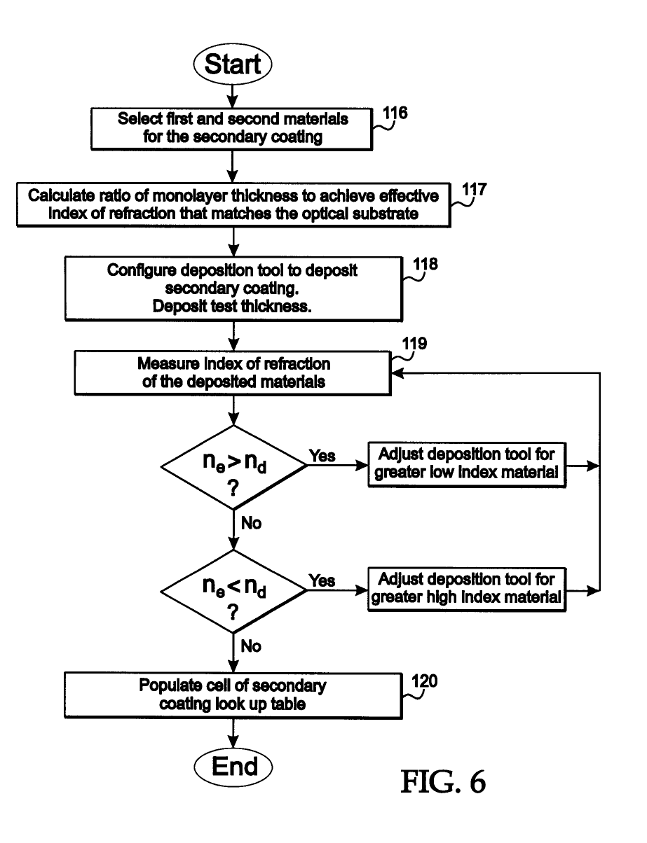

With specific reference to FIG. 6 of the drawings, it is suggested that one of the many possible empirical methods for populating the secondary coating look up table first selects 116 appropriate first and second materials 109, 110. The first and second materials 109, 110 are selected such that the combination of the first and second materials 109, 110 exhibits some amount of compressive stress. In addition, the first material 109 has an index of refraction (n₁) that is less than the defined index of refraction (n_{d}) and the second material 110 has an index of refraction (n₂) that is greater than the defined index of refraction (n_{d}). In a specific embodiment, the low index material is most commonly silica. In a specific embodiment, the high index material is Niobia, but may also be any one of other high index materials such as Titania (i.e. titanium dioxide TiO₂), Tantala (Ta₂O₅), Hafnia (HfO₂), Alumina (Al₂O₃), and Zirconia (ZrO₂).

Based upon the design wavelength of light, a thickness of the composite monolayer, t_{cml} is selected to be less than 10% and typically less than 1% of the design wavelength of light. Based upon the indices of refraction, n₁ and n₂, for the first and second materials 109, 110, and the thickness of the composite monolayer, t_{cml}, the method calculates 117 appropriate monolayer thicknesses, t₁ and t₂, for the first and second materials 109, 110 that arrives at the defined index of refraction, n_{d}. In one embodiment, the calculation step uses equation (1). The results of the relative thickness of the composite monolayer are used to inform the first settings of the co-deposition tool.

Based upon the calculated ratio, the deposition tool is configured 118 to deposit alternating monolayers of the first and second materials 109, 110 of the approximate established thicknesses, t₁ and t₂. As one of ordinary skill in the art appreciates, the deposition tool does not typically provide deposition parameters that directly relate to monolayer thicknesses. More commonly, the deposition tool provides settings comprising the power ratio and gas pressure ratio for the deposition of each material in a co-deposition process. Accordingly, it is desirable to establish and store a relationship between the power and gas pressure ratio settings of the deposition tool to the index of refraction achievable for specific first and second materials 109, 110. It is suggested that this relationship is best stored as a look up table, which is referred to herein as the refraction index look up table. In a specific embodiment of the refraction index look up table, columns represent a power ratio and rows represent gas pressure ratio parameters for the tool. A sample secondary coating 108 is deposited 118 for specific power and gas pressure ratio settings and the index of refraction is measured 119. If the measured effective index of refraction is above the defined index of refraction, the deposition tool is adjusted to increase the amount of the low index material that is deposited relative to the high index material. Another deposition is made 118 and measured 119. This process iterates until the defined index of refraction is achieved. Once achieved, the appropriate cell of the secondary coating look up table is populated 120. When a specific index of refraction is desired, it is possible to look up an exact index of refraction, which provides the appropriate deposition tool settings. Alternatively, a specific index of refraction may be bounded by two indices of refraction. In this case, it is possible to interpolate the appropriate settings for the deposition tool to arrive at the desired value. Additional look up tables may be built for different first and second material 109, 110 combinations.

The deposition tool deposits multiple composite layers 130 of the appropriate index of refraction to create the secondary coating 108 that balances the compressive stress of the primary coating. Accordingly, it is suggested that another one or more look up table(s), referred to herein as substrate look up tables, are developed for each substrate 100 and first and second material combination that defines a thickness of the secondary coating 108 as a function of substrate aspect ratio and primary coating thickness. The substrate look up table represents a specific substrate material, a specific first material, and a specific second material. Columns of the substrate look up table represent the total primary coating thickness and rows of the substrate look up table represent an aspect ratio of the substrate 100. The aspect ratio of the substrate 100 is defined as the diameter or diagonal of the substrate 100 to the substrate thickness. Cells of the substrate look up table are populated with a total secondary coating thickness for the aspect ratio/primary coating thickness.

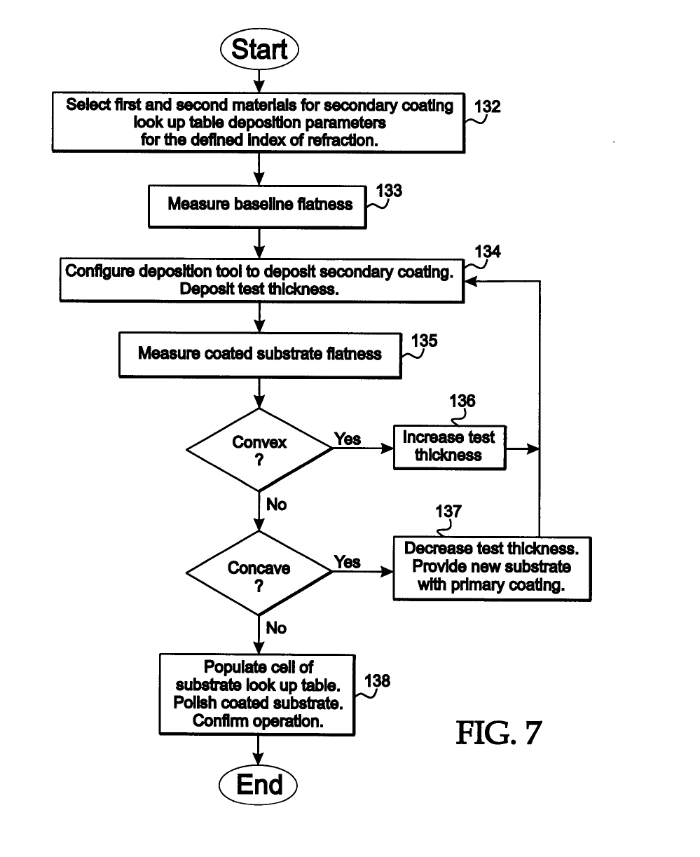

With specific reference to FIG. 7 of the drawings, there is shown a flow chart for an embodiment of a process according to the present teachings that populates the substrate look up table. For a specific substrate and primary coating, a first and second material 109 combination is selected 132 and the secondary coating look up table is used to obtain 132 appropriate parameters to configure the deposition tool for the defined index of refraction, n_{d}, of the substrate 100. The process then measures 133 a flatness of a primary surface 130 of the optical substrate 100 to establish a baseline measurement of warping due to the compressive stress of the primary coating 103 before the secondary coating 108 is applied. The deposition tool is configured 134 and multiple composite layers are deposited 134 until a test thickness of the secondary coating 108 is deposited onto the optical substrate 100. The flatness of the primary surface 130 is measured 135 again. In a specific embodiment, flatness is measured using a conventional measurement tool and typically as a fraction of 633 nm. In a specific example, flat is defined as the peak-to-valley of the primary surface 130 being less than or equal to 63.3 nm. As one of ordinary skill in the art appreciates, other flatness limits are a matter of design choice and are consistent with the present teachings.

It is suggested that the test thickness is initially set to be half of the thickness of the primary coating 103 for purposes of developing the appropriate secondary coating recipe and is then adjusted based upon a measured flatness of the coated substrate. The test thickness may be calculated as a function of the number of composite monolayers, m, using equation (3).

If the primary surface 130 is still convex, the test thickness of the secondary coating 108 is increased 136 and additional composite monolayers are deposited 134 until the adjusted test thickness is achieved. As one of ordinary skill in the art appreciates, the deposited composite monolayers 130 must be complete in order to maintain the effective index of refraction, n_{d}. The process repeats until the coated substrate is measured as flat within the acceptable limits or is measured as concave.

If the coated optical substrate becomes concave, it indicates that the secondary coating 108 is too thick and exhibits more compressive stress than the primary coating 103. In that case, the test thickness is decreased 137 and the process starts over by providing 137 a new optical substrate having only the primary coating 103.

If after the secondary coating 108 is deposited, the measured primary surface 130 is neither convex or concave, it is considered flat within an acceptable range. The coated substrate is then polished 138, its operation is confirmed and the appropriate cell is populated in the substrate look up table for later reference. As one of ordinary skill in the art appreciates, a thicker secondary coating 108 provides more compressive stress than its thinner counterpart. One of ordinary skill in the art also appreciates that a substrate with a smaller aspect ratio requires less balancing compressive stress than the same substrate with a larger aspect ratio. Therefore, the substrate table advantageously informs the starting point for other substrates to minimize the number of iterations that are necessary to arrive at the recipe for the specific secondary coating 108 that achieves flatness for a particular coated substrate.

It is likely that deposition tools are not consistent from machine to machine. Therefore, it may be beneficial to develop and maintain multiple secondary coating and substrate look up tables that are relevant to a particular deposition tool.

In another possible embodiment according to the present teachings, more than two materials may be combined to form a composite monolayer and the secondary coating 108. The more generalized function to calculate the defined index of refraction for the composite monolayer having up to x number of materials becomes:

n₁t₁+n₂t₂+n₃t₃+ . . . +nₓtₓ=n_{d}t_{cml} (4)

Wherein n_{d} is the defined index of refraction and t_{cml} is the total thickness of the composite monolayer and is less than 10% of the design wavelength and typically less than 1% of the design wavelength. The calculation for the secondary coating thickness is similarly generalized.

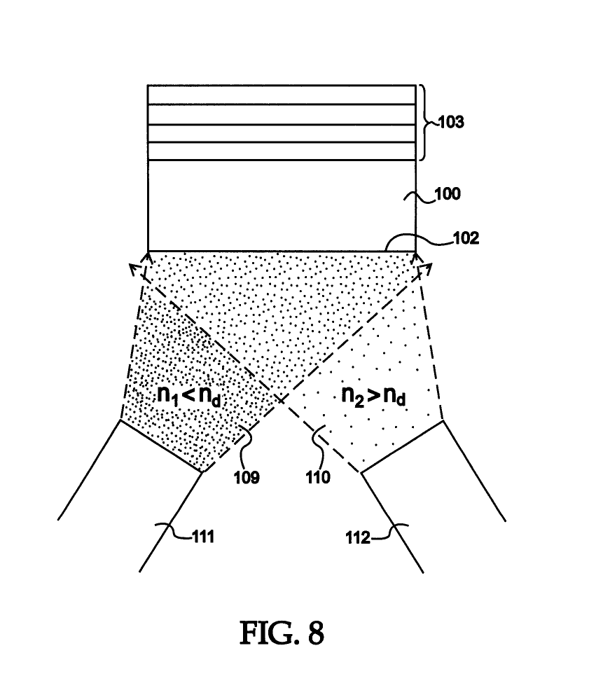

In yet another possible embodiment according to the present teachings, the first and second materials may be deposited simultaneously, rather than in alternating monolayers, wherein a rate of deposition conforms to the calculated ratio of first and second materials 109, 110 to arrive at the secondary coating 108 having the desired index of refraction, n_{d}. With specific reference to FIG. 8 of the drawings, there is shown a diagram wherein the first and second materials 109, 110 are deposited at respective rates in units of volume of material per unit of time. If the rate of deposition is adjusted for each of the first and second materials, simultaneous deposition can combine the materials during the deposition process according to the calculated ratio that arrives at the desired index of refraction. In the illustrated example above, the rate of deposition of the first material is 19 times that of the rate of deposition of the second material. The thickness of the secondary coating 108 defines the compressive stress that opposes the compressive stress of the primary coating 103 in the same way as previously described. As one of ordinary skill in the art appreciates, the embodiment using simultaneous deposition may also be used with more than two materials to create the secondary coating 108.

Embodiments of the teachings are described herein by way of example with reference to the accompanying drawings describing an optical substrate apparatus and method for its manufacture wherein a secondary coating is deposited as a stress balancing layer to improve optical substrate flatness. A preferred embodiment is disclosed that deposits alternating monolayers of first and second materials to create the secondary coating 108. One or ordinary skill in the art with benefit of the present teachings, however, appreciates that there are variations and adaptations that are consistent with the present teachings and within the scope of the appended claims. For example, many different materials may be appropriate to make up the secondary coating and the secondary coating may also be made by simultaneous deposition of more than two different materials. Other variations, adaptations, and embodiments of the present teachings will occur to those of ordinary skill in the art given benefit of the present teachings.

1. An apparatus:
An optical substrate having a defined refractive index,
A primary optical coating disposed on a first major surface of the substrate, and
A secondary coating having a refractive index substantially similar to the defined refractive index, the secondary coating disposed on a second major surface of the substrate.

2. An apparatus as recited in claim 1 wherein the secondary coating comprises alternating monolayers of at least first and second materials.

3. An apparatus as recited in claim 2 wherein a thickness of each monolayer is no more than 10% of a design wavelength of light.

4. An apparatus as recited in claim 2 wherein a composite monolayer comprising first and second material monolayers is no more than 1% of a design wavelength.

5. An apparatus as recited in claim 1 wherein the secondary coating comprises at least two simultaneously applied first and second materials.

6. An apparatus as recited in claim 2 wherein the first material has an index of refraction that is more than the defined index of refraction and the second material has an index of refraction that is less than the defined index of refraction.

7. An apparatus as recited in claim 2 wherein the first material is a metal oxide or a metal flouride.

8. An apparatus as recited in claim 7 wherein the first material is selected from the group consisting of SiO₂ and MgF₂.

9. An apparatus as recited in claim 2 wherein the second material is a metal oxide.

10. An apparatus as recited in claim 9 where in the second material is selected from the group consisting of Nb₂O₅, Ta₂O₅, TiO₂, HfO₂, ZrO₂, Al₂O₃, Y₂O₃, and Sc₂O₃.

11. A method for manufacturing a thin film comprising
Depositing a primary coating onto a first major surface of an optical substrate, the optical substrate having a defined refractive index and the primary coating exhibiting compressive stress, and
Depositing a secondary coating onto a second major surface of the optical substrate that exerts a substantially equal and opposite compressive stress, the secondary coating having a refractive index substantially similar to the defined refractive index.

12. A method as recited in claim 11 wherein the secondary coating comprises depositing alternating monolayers of at least first and second materials on the second major surface.

13. A method as recited in claim 12 wherein each monolayer is no more than 10% of a design wavelength of light.

14. A method as recited in claim 11 wherein the first material has an index of refraction that is more than the defined index of refraction and the second material has an index of refraction that is less than the defined index of refraction.

15. A method as recited in claim 11 wherein the first material is selected from a group consisting of metal oxides and metal fluorides.

16. A method as recited in claim 15 wherein the first material is selected from the group consisting of SiO₂ and MgF₂.

17. An apparatus as recited in claim 11 wherein the second material is a metal oxide.

18. An apparatus as recited in claim 17 wherein the second material is selected from the group consisting of Nb₂O₅, Ta₂O₅, TiO₂, HfO₂, ZrO₂, Al₂O₃, Y₂O₃, and Sc₂O₃.

19. A method comprises
Providing an optical substrate with a primary coating, wherein the primary coating exhibits compressive stress,
Depositing a test thickness of a secondary coating on the coated optical substrate, the secondary coating having an index of refraction substantially equal to an index of refraction of the optical substrate,
Measuring a flatness of the optical substrate having the primary and secondary coating,
Adjusting the test thickness if the flatness is not within acceptable limits, and
Repeating the steps of depositing and measuring until the flatness measurement is within the acceptable limits.

20. A method as recited in claim 19 wherein depositing the secondary coating comprises depositing alternating monolayers of at least first and second materials.

21. A method as recited in claim 20 wherein a thickness of each monolayer is no more than 10% of a design wavelength of light.

22. A method as recited in claim 20 wherein a thickness of each monolayer is no more than 1% of a design wavelength of light.

23. A method as recited in claim 19 wherein the acceptable limits are measured as a function of a difference between the maximum peak and maximum valley of the optical substrate surface

24. A method as recited in claim 19 and further comprising storing the recipe for the primary coating, the recipe comprising at least the first and second materials, thicknesses of the first and second material monolayers, and a thickness of the secondary coating.
